(19) United States
(12) Patent Application Publication
(10) Pub. No.: US 2007/0133546 A1
(43) Pub. Date: Jun. 14, 2007

(54) Method for providing QoS using address system and system resolution protocol

(75) Inventors: Bong Wan Kim, Daejeon (KR); Yoo Kyoung Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics & Telecommunications Research Institute

(21) Appl. No.: 11/634,444

(22) Filed: Dec. 5, 2006

(30) Foreign Application Priority Data
Dec. 8, 2005 (KR) 10-2005-0119823
Sep. 29, 2006 (KR) 10-2006-0096552

(51) Int. Cl. H04L 12/56

(52) U.S. Cl. 370/392; 370/401

(57) ABSTRACT

Provided is a method for providing quality of service (QoS) in a network including multiple nodes using an address system and an address resolution protocol (ARP). The method includes, at a current node, receiving a service request packet from a previous node using the address system and the ARP, checking whether the service request packet includes QoS request information, and determining whether the current node is capable of satisfying the QoS request. If the determination is affirmative, the current node transmits the service request packet with the QoS request information to a next node using the address system and the ARP. If the current node receives a reply packet from the next node, the current node determines whether the reply packet satisfies the QoS request. If the determination is affirmative, the reply packet including an address value of the current node is transmitted to the previous node.

### RELATED APPLICATION

This application claims the benefits of Korean Patent Application No. 2005-0119823 filed on Dec. 8, 2005 and Korean Patent Application No. 2006-96552 filed on Sep. 29, 2006 in the Korean Intellectual Property Office, the disclosures of which are incorporated herein by reference.

### BACKGROUND OF THE INVENTION

1. Field of the Invention

The present invention relates to a quality of service (QoS) guarantee between network devices, and more particularly, to a method and an apparatus for providing QoS satisfying a user's desired traffic condition by exchanging information about traffic processing based on a physical address system and an address resolution protocol (ARP) between network devices.

1. Description of the Related Art

As computer and telecommunication technologies have been advanced, transmission of complex and enormous amounts of information is generally required. Thus, traffic capacity for network devices has also been abruptly increased. To satisfy these requirements, network devices have been evolved to have large capacity and operate at high speed. Especially, many researches have been actively carried out to guarantee traffic QoS associated with traffic transmission between network devices.

Typically, a procedure of reserving necessary resources for nodes in an intermediate path between a starting point and an end point of traffic is precedently performed using a telecommunication protocol such as a resource reservation protocol (RSVP). After the precedent reservation, traffic is allowed to pass through the intermediate path. Also, a network device in the intermediate path adds specifically assigned information such as a multi-protocol label switching (MPLS) for every packet to determine how the traffic uses the precedently reserved resources. Alternatively, the network device looks up numerous pieces of information including addresses of the starting and end point of a packet header and determines which reserved resource is used in the traffic.

However, the above described method may not be practically applicable due to complexity in RSVP, packet enlargement caused by label tagging, and a large amount of computation required for searching for various information included in packet headers.

Furthermore, as one method of providing QoS suitable for traffic in a network, U.S. Pat. No. 6,859,438 issued to S. R. Haddock on Feb. 22, 2005, entitled “Policy Based Quality of Service” teaches a data communication method for achieving true QoS by classifying traffic groups based on priority information in a packet header in a network and scheduling the packet according to one of the classified traffic groups. However, this introduced method does not schedule the traffic by reserving resources in sequence according to the path. Rather, this method schedules the packet according to the classification of the traffic groups based on the priority. Thus, it may be difficult to guarantee QoS for each of the traffic.

As described above, the conventional resource reservation method using RSVP is generally complex. As like the above mentioned MPLS, an additional header is added for each packet, and thus, the packet may become complex and enlarged structurally. In some cases, many parts of a packet often need to be searched for using a complex method to classify traffic groups in a network device according to the priority. Accordingly, despite of feasibility, the conventional resource reservation method may be complex and difficult to be applied in an actual network device because of a limitation in cost.

### SUMMARY OF THE INVENTION

The present invention has been made to solve the foregoing problems of the prior art and it is therefore an object of certain embodiments of the present invention to provide a method and an apparatus for providing QoS satisfying a user's desired traffic condition by exchanging traffic processing information using a physical address system and an ARP between network devices.

Another object of the present invention is to provide a method and an apparatus for providing QoS by reserving network resources for QoS simply using an address system and an ARP instead of a complex telecommunication protocol (e.g., RSVP).

According to an aspect of the present invention, there is provided a method for providing QoS using an address system and an ARP in a network including a plurality of nodes, the method including the steps of: (a) at a current node, receiving a service request packet from a previous node using the address system and the ARP, checking whether the service request packet includes QoS request information, and determining whether the current node is capable of satisfying the QoS request, (b) if the determination is affirmative, at the current node, transmitting the service request packet including the QoS request information to a next node using the address system and the ARP, (c) at the current node, if receiving a reply packet to the service request packet from the next node using the address system and the ARP, determining whether the reply packet satisfies the QoS request, and (d) if the determination is affirmative, transmitting the reply packet including an address value of the current node satisfying the QoS request to the previous node using the address system and the ARP.

In one embodiment, the service request packet including the QoS request may be transmitted from a source node to a destination node through the intermediate nodes in sequence, each of the nodes reserving a network resource necessary for the QoS request.

In one embodiment, the QoS request information may be included in an address value of a physical layer 2 within the service request packet.

In one embodiment, the step (a) may further includes (a-1) checking whether the service request packet includes the QoS request information, (a-2) if the checking result is negative, adding an address value corresponding to the requested QoS into the reply packet when QoS for a source address is specified, and transmitting the reply packet to the previous node using the address system and the ARP, and (a-3) if the QoS for the source address is not specified, adding a default interface address value into the reply packet and transmitting the reply packet to the previous node using the address system and the ARP.

In one embodiment, after the step (a), the method may further include, if the current node is not capable of satisfying the QoS request, adding a default interface address value into the reply packet and transmitting the reply packet to the previous node using the address system and the ARP.

In one embodiment, the step (b) may further include reserving a necessary network resource for the QoS request.

In one embodiment, the step (b) may further include, if the QoS request is not satisfied, at the current node, transmitting the reply packet including a message indicating the QoS request is not satisfied using the address system and the ARP.

In one embodiment, the step (b) may further include generating a QoS table depending on a destination address of a packet to be served, and looking up a destination address of the received service request packet using the QoS table.

In one embodiment, the step (c) may further include determining whether the reply packet from the next node is received, if the determination is negative, checking whether to provide partial QoS, and if the partial QoS is to be requested from the previous node, adding an address value satisfying the requested partial QoS into the reply packet and transmitting the reply packet to the previous node using the address system and the ARP, and if the partial QoS is not requested, adding a default interface address value into the reply packet and transmitting the reply packet to the previous node using the address system and the ARP.

According to another aspect of the present invention, there is provided a method for providing QoS using an address system and an ARP in a network including a plurality of nodes, the method including the steps of (a) at a current node, when an application program requests QoS, adding the QoS request information into a service request packet and transmitting the service request packet to a next node using the address system and the ARP, (b) at the current node, receiving a reply packet to the service request packet from the next node using the address system and the ARP, (c) at the current node, if receiving the reply packet indicating that the QoS request is satisfied, providing a service suitable for the QoS using an address of the next node included in the reply packet, and (d) at the current node, if receiving the reply packet indicating that the QoS request is not satisfied, providing a service suitable for default QoS.

In another embodiment, the service request packet including the QoS request information may be transmitted from a source node to a destination node through intermediate nodes in sequence.

In another embodiment, the step (c) may further include reserving a necessary network resource for the QoS request.

In another embodiment, the step (b) may further include, at the current node, if not receiving the reply packet within a preset period of time, adding information indicating that the QoS request does not exist into the service request packet and transmitting the service request packet to an address of the next node.

According to a further aspect of the present invention, there is provided a method for proving QoS in a network including a plurality of nodes using an address system and an ARP, the method including the steps of (a) at a current node, if receiving a service request packet using the address system and the ARP, determining whether the service request packet includes QoS request information, (b) if the service request packet includes the QoS request information, determining whether an available network resource is capable of satisfying the QoS request, (c) if the determination is affirmative, reserving a necessary network resource for the QoS request, adding information indicating that the network resource is capable of satisfying the QoS request into a reply packet and transmitting the reply packet to a previous node using the address system and the ARP, and (d) if the determination is negative, adding information indicating that the network resource is not capable of satisfying the QoS request into a reply packet and transmitting the reply packet to the previous node using the address system and the ARP.

In further another embodiment, the service request packet including the QoS request information may be transmitted from a source node to a destination node through intermediate nodes in sequence.

In further another embodiment, the QoS request information may be included in an address value of a physical layer 2 within the service request packet.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates a diagram of a network architecture according to an embodiment of the present invention;

FIG. 2 illustrates a block diagram of an internal part of a network device according to an embodiment of the present invention;

FIG. 3 is a flowchart to illustrate a method for providing QoS using an address system and an ARP in a network device according to an embodiment of the present invention;

FIG. 4 is a flowchart to illustrate a procedure of processing a service request packet using an address system and an ARP in a network terminal according to an embodiment of the present invention; and

FIG. 5 is a flowchart to illustrate a procedure of processing a reply packet using an address system and an ARP in a network terminal according to an embodiment of the present invention.

### DETAILED DESCRIPTION OF THE PREFERRED EMBODIMENT

The present invention will now be described more fully hereinafter with reference to the accompanying drawings, in which preferred embodiments of the invention are shown. It should be noted that those known functions and configurations related to the present invention will not be described in detail if it is determined that the detailed description thereof may make the scope of the present invention ambiguous.

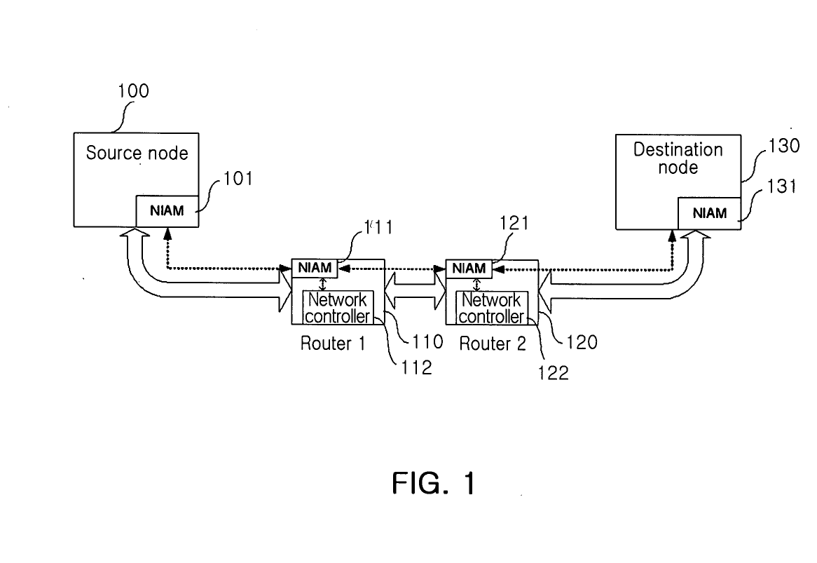

FIG. 1 illustrates a diagram of a network architecture according to an embodiment of the present invention. The network configured to provide a method for providing QoS using a physical address system and an ARP includes a source node 100, a destination node 130, which is a terminal responsible for packet transmission, and a plurality of routers 110 and 120 routing a packet between the source node 100 and the destination node 130. The source node 100 and the destination node 130 may be terminals including personal computers and Internet servers containing various data. Vast amounts of data are transmitted between the source node 100 and the destination node 130, and especially, video data usually require a large capacity bandwidth in a certain scale or larger. In many cases, QoS such as a voice over Internet protocol (VoIP) may also need to be directly provided between individual users. One exemplary network according to the present embodiment is illustrated in FIG. 1, and it is apparent for those skilled in the art that various nodes or routers can exist in this exemplary network.

Transmission of a packet between the source node 100 and the destination node 130 requires precedently sending necessary QoS information through the network devices such as the routers 110 and 120 based on a certain protocol and reserving network resources for QoS. For the resource reservation, network interface address managers (NIAMs) 101, 111, 121, and 131 are installed to find out a physical address system (i.e., an address of a certain physical layer) using an ARP, and precedently reserve resources for providing QoS. The NIAMs 101, 111, 121, and 131 implement QoS by exchanging information with network controllers 112 and 122 responsible for protocol processing in the typical network device.

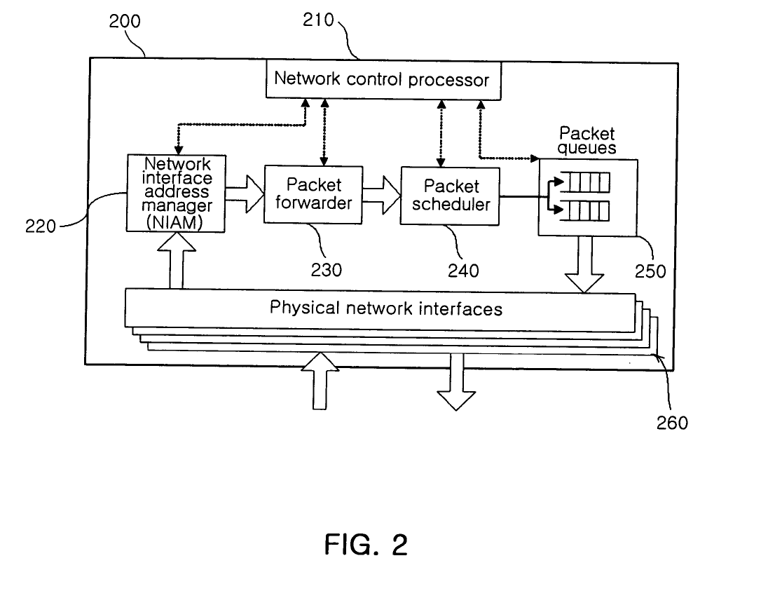

FIG. 2 illustrates a block diagram of an internal part of a network device according to an embodiment of the present invention. The network device 200 for a method for providing QoS using an address system and an ARP includes a network control processor 210, an NIAM 220, a packet forwarder 230, a packet scheduler 240, packet queues 250, and a plurality of physical network interfaces 260. The network control processor 210 manages and controls an overall traffic flow of the network device 200. The NIAM 220 performs a precedent resource reservation procedure of providing QoS using an ARP. The packet forwarder 230 transmits packets. The packet scheduler 240 determines and manages an appropriate point of outputting packets. The packet queues 250 contain designated output packets, which are divided into groups according to the same destination or a certain divisional rule, and wait for queues. The physical network interfaces 260 provide a physical interface to the external network of the device.

Generally, an address system of the Internet is configured in layers. Among the configured layers, a layer (L2) and a layer 3 (L3) are often considered to be the most important. Particularly, an address of the layer (L2) is an address of a physical layer called “media access control” (MAC), and is indicative of an address in a line physically connected to a network interface. For instance, if two network devices are connected with each other through one line, communications are allowed even though any value is applied to the layer 2 in between the two network devices. However, in the case of Ethernet, which is a typical physical structure in the Internet, multiple network devices can be connected simultaneously to one line through coaxial cables. In such a case, since interfaces of the individual network devices have different L2 addresses, the interfaces can be distinguished from each other. Currently, an L2 region physically extends due to devices including hubs and repeaters, and thus, an increasing number of network devices define one L2 region and are distinguished from each other based on the different L2 addresses.

As compared with the L2 address, which is sufficiently unique in the same line, an address of the layer 3 is unique worldwide, and functions as a guide to find out a specific destination on the Internet. A hub is one representative network device connecting networks based on the L2 address, while a router is one representative network device connecting networks based on the L3 address. A router previously acknowledges path information about a distribution of the network devices having the L3 address worldwide, looks up a destination L3 address inputted through a network interface (i.e., performs an internal packet search procedure) and outputs the packet to an interface connected to the destination.

A network device for the layer 3 such as a router searches for a next hop (i.e., an L2 address in a network device through which the packet is to pass) based on the destination L3 address and changes the destination L2 address of the packet to be transmitted into an L2 address of an interface for a next network device (i.e., the subsequent next hop). This procedure of finding out the L2 address proceeds according to the ARP.

The Internet Engineering Task Force Request For Comments (IETF RFC) 826 defines the ARP. When it is desired to find out an L2 address of a destination with a specific L3 address, an ARP request packet including an address of the ARP request packet and the L3 address of the destination is broadcasted to devices connected to a network interface. When the device determines that the L3 address of the destination is the address of the device itself or the packet passes through the device, the device sends an ARP reply informing the L2 address of the device itself to the device broadcasting the ARP request packet.

The layer 2 of a network generally has one address value; however, in the present embodiment, this address value is used as a value specified according to the each QoS value. The ARP standard allows adding additional information to ARP packets. In the present embodiment, a QoS request is added into an ARP request packet and broadcasted to network interfaces. A destination device, which acts as a next hop, examines whether it can accept the QoS request, reserves an available network resource, and sending an ARP reply packet to a device transmitting the QoS request. This type of QoS proceeds sequentially from the source to the destination. Although a resource of any one intermediate network device between the source and the destination can satisfy the QoS request, since a device in the next path may not satisfy the QoS request, each intermediate device relays the ARP request packet to a next hop, receives from a device of the next hop an affirmative reply that the device of the next hop can satisfy the QoS request, and sends an ARP reply packet to the network device of the previous hop.

For this effect, the NIAMs 101, 111, 121, and 131 illustrated in FIG. 1, and the NIAM 220 illustrated in FIG. 2 receive the ARP request packet, interpret the received ARP request packet, and generate an ARP reply packet to the request. In detail, the NIAMs 101, 111, 121, and 131, and the NIAM 220 have QoS tables. If the NIAMs 101, 111, 121, and 131 and the NIAM 220 can satisfy the QoS request, they update the QoS tables and reserve an available resource. Also, the NIAMs 101, 111, 121, and 131 and NIAM 220 inform the packet forwarder 230 of a packet transmission path, and allows the packet scheduler 240 to schedule the packet output corresponding to the QoS request. If necessary, the packet queues 250 are divided into certain groups and allocated for the above procedure.

The L2 address value of the interface for the destination network device, the L2 address value being sent as the ARP replay packet, is a unique value in the L2 region. Particularly, in the present embodiment, this address value is a specified value that is generated to correspond to the QoS request by the QoS device to which the present embodiment is applied. Since this address value is set to correspond to a specific QoS table, the network device can quickly provide the requested QoS whose information is included in the ARP request packet upon the arrival of the ARP request packet.

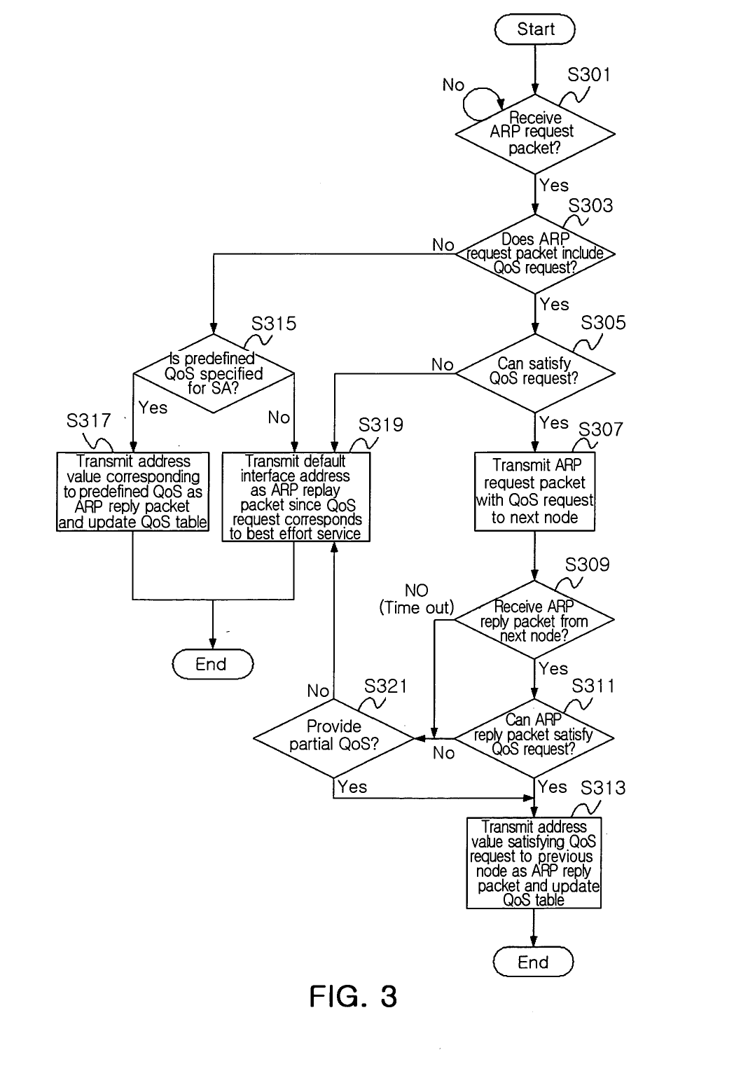

FIG. 3 is a flowchart to illustrate a method for providing QoS using an ARP in a network device according to an embodiment of the present invention.

In operation of S301, it is determined whether the network device receives an ARP request packet. If the receipt is affirmative, in operation of S303, the network device determines whether the ARP request packet includes QoS request information. If the QoS request is not included, the ARP request packet is a general ARP packet. In this case, two procedures can be possible depending on an address of a source node (herein referred to as SA) More specifically, in operation of S315, it is determined whether basic QoS is specified for the source node. If the predefined QoS is specified, in operation of S317, an address value corresponding to the predefined QoS is sent as an ARP reply packet, and a QoS table is updated. If the predefined QoS is not specified, a best effort service, i.e., no QoS, is to be provided. Thus, in operation of S319, a default interface address value is sent as the ARP reply packet. As similar to the case of connecting information-based electric home appliances to a home network device, this procedure allows a device that is not implemented with the present embodiment to provide QoS by predefined setting a specific SA. For instance, even though an information-based electric home appliance is not implemented with the present embodiment, QoS can still be provided as long as the present embodiment is implemented to a home network device. In particular, like the information-based electric home appliances where various application programs are not performed, the present embodiment is useful for those devices using a network for a fixed purpose, and thus having a simple traffic pattern.

In operation of S303, if the ARP request packet is determined to have the QoS request, then, in operation of S305, it is determined whether the current network device can satisfy the QoS request. If the determination is negative, in operation of S319, the default interface address is sent as the ARP reply packet to provide the best effort service. If the determination is affirmative, in operation of S307, the network device relays the ARP request packet including the QoS request to a next hop.

In operation of S309, it is determined whether an ARP reply packet arrives at the next hop. If the ARP reply packet arrives, in operation of S311, it is determined whether the received ARP reply packet satisfies the QoS. If the determination is affirmative, in operation of S313, an address value corresponding to the requested QoS is sent to the previous node as an ARP reply packet, and the QoS table is updated. If the ARP reply packet does not arrives at the next hop for a given period set in operation of S309, or the ARP reply packet arriving at the next hop dose not satisfy the requested QoS, in operation of S321, it is determined whether partial QoS is to be provide. If the determination is affirmative, the operation of S313 proceeds, and if otherwise, the operation of S319 proceeds.

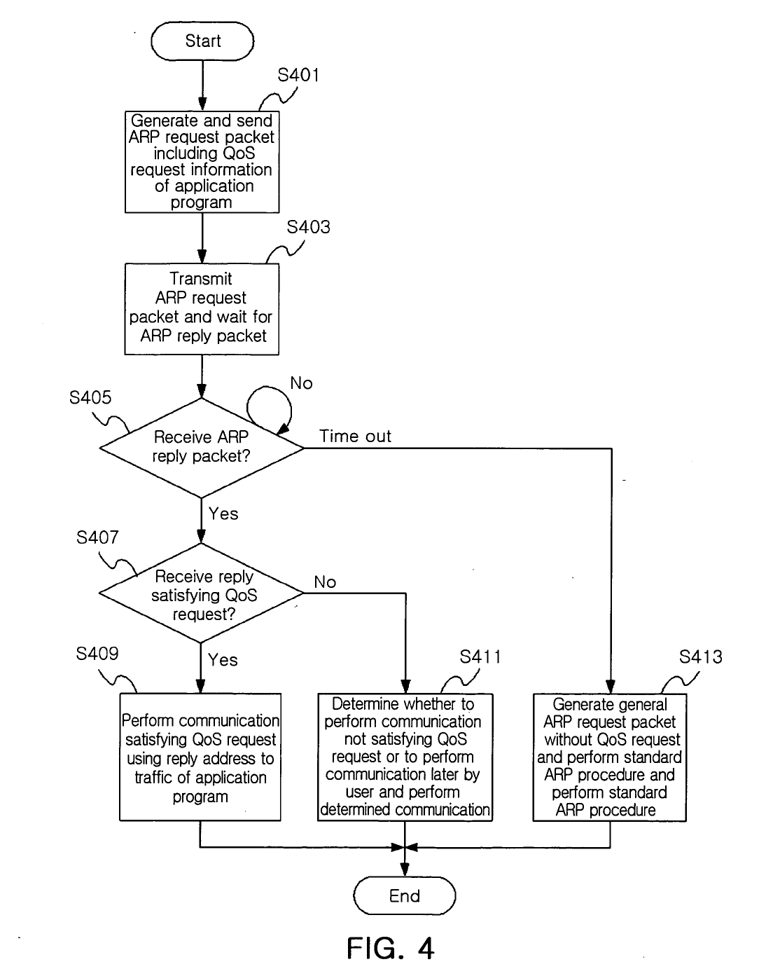

FIG. 4 is a flowchart to illustrate a request procedure in an ARP in a network terminal according to an embodiment of the present invention.

In operation of S401, when an application program requests QoS, the network terminal generates an ARP request packet including the QoS request information and broadcasts the ARP request packet to other network terminals. In operation of S403, the network terminal awaits for a reply to the ARP request packet. In operation of S405, if the ARP reply packet is received at the network terminal, it is determined whether the received ARP reply packet satisfies the QoS request. If the determination is affirmative, in operation of S409, a communication satisfying the requested QoS is performed using a reply address to the traffic of the application program. If the determination is negative, in operation of S411, a user determines whether to perform a communication that does not satisfy the requested QoS or to perform a communication later, and the determined communication is performed. In operation of S405, if the ARP reply packet is not received within a given period, a general ARP request packet without the QoS request information is generated, and a typical ARP procedure is performed in operation of S413.

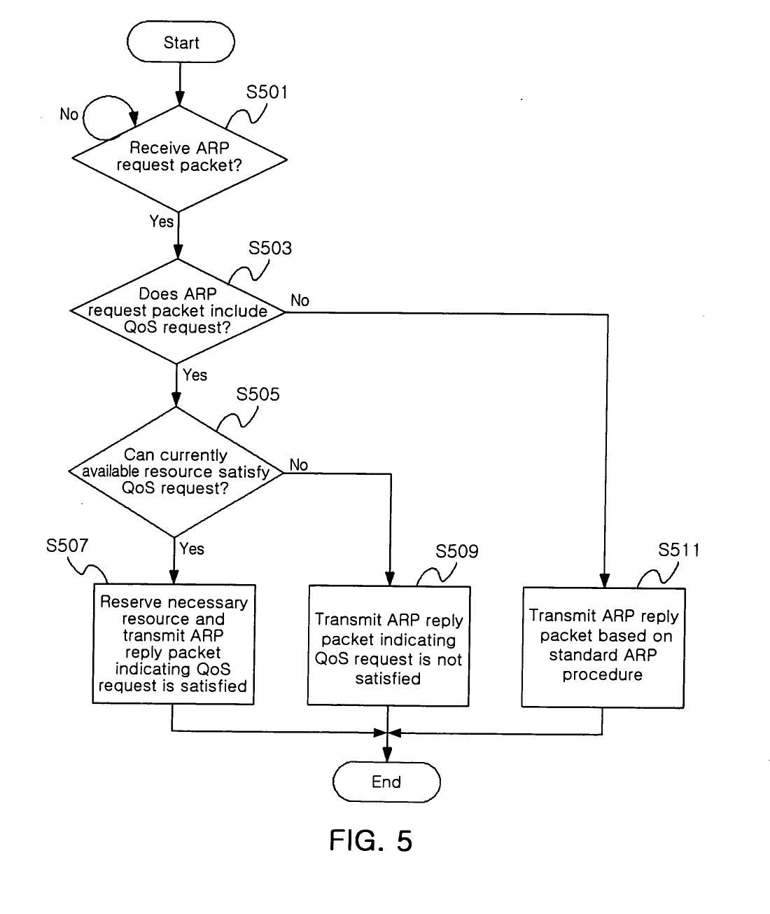

FIG. 5 is a flowchart to illustrate a reply procedure in an ARP in a network terminal according to an embodiment of the present invention.

In operation of S501, when the network terminal receives an ARP request packet, it is determined in operation of S503 whether the ARP request packet includes a QoS request. If the ARP request packet includes the QoS request, in operation of S505, it is checked whether the currently available resource can satisfy the QoS request. If the QoS request can be satisfied, in operation of S507, the necessary resource is reserved, and an ARP reply packet indicating the QoS request can be satisfied is sent to a target terminal. If the QoS request cannot be satisfied, in operation of S509, an ARP reply packet indicating the QoS request cannot be satisfied is sent to the source terminal. If it is determined in operation of S503 that the ARP request packet does not include the QoS request, in operation of S511, an ARP reply packet according to the standard ARP procedure is sent to the source terminal.

According to various embodiments of the present invention, since an L2 address value includes QoS information, QoS can be provided simply and effectively using an ARP without adding an additional header or field to a packet.

Also, instead of looking up many parts of the packet to search for the QoS information, the QoS information can be found out by simply looking up the L2 address including the QoS information. As a result, the desired QoS can be easily and simply provided.

The L2 address of the Ethernet is generally in 48 bits. The uppermost 24-bit uses a specified value for each network device company through a standardization organization, and the lowermost 24-bit uses a specified value for each device. On the basis of the present embodiment, the uppermost 24-bit is registered in the standardization organization, and the lowermost 24-bit is specified as 2²⁴ of individual QoS in the L2 region. Hence, since the desired QoS can be provided by looking up 24 bits, the packet processing method according to the embodiment of the present invention can be performed more rapidly than the conventional method.

The protocol for proving the requested QoS uses the known standard ARP, and thus, the desired QoS can be provided, being compatible with a network device to which the present embodiment is not applied.

Furthermore, even though QoS is provided between devices and a device to which the present embodiment is not applied requests providing QoS through an ARP request packet, appropriate QoS can be provided by setting a predefined QoS value of a corresponding device.

While the present invention has been described with reference to the particular illustrative embodiments and the accompanying drawings, it is not to be limited thereto but will be defined by the appended claims. It is to be appreciated that those skilled in the art can substitute, change or modify the embodiments into various forms without departing from the scope and spirit of the present invention.

What is claimed is:

1. A method for providing QoS (quality of service) using an address system and an ARP (address resolution protocol) in a network including a plurality of nodes, the method comprising the steps of:
a) at a current node, receiving a service request packet from a previous node using the address system and the ARP, checking whether the service request packet includes QoS request information, and determining whether the current node is capable of satisfying the QoS request;
b) at the current node, transmitting the service request packet including the QoS request information to a next node using the address system and the ARP, if the determination is affirmative;
c) at the current node, determining whether the reply packet satisfies the QoS request, if receiving a reply packet to the service request packet from the next node using the address system and the ARP; and
d) transmitting the reply packet including an address value of the current node satisfying the QoS request to the previous node using the address system and the ARP, if the determination is affirmative.

2. The method according to claim 1, wherein the service request packet including the QoS request is transmitted from a source node to a destination node through the intermediate nodes in sequence, each of the nodes reserving a network resource necessary for the QoS request.

3. The method according to claim 1, wherein the QoS request information is included in an address value of a physical layer 2 within the service request packet.

4. The method according to claim 1, wherein the step a) further comprises:
a-1) checking whether the service request packet includes the QoS request information;
a-2) if the checking result is negative, adding an address value corresponding to the predefined QoS into the reply packet when QoS for the source address is specified, and transmitting the reply packet to the previous node using the address system and the ARP; and
a-3) if the QoS for the source address is not specified, adding a default interface address value into the reply packet and transmitting the reply packet to the previous node using the address system and the ARP.

5. The method according to claim 1, wherein after the step a), further comprising, if the current node is not capable of satisfying the QoS request, adding a default interface address value into the reply packet and transmitting the reply packet to the previous node using the address system and the ARP.

6. The method according to claim 1, wherein the step b) further comprises reserving a necessary network resource for the QoS request.

7. The method according to claim 1, wherein the step b) further comprises:
generating a QoS table depending on a destination address of a packet to be served; and
looking up a destination address of the received service request packet using the QoS table.

8. The method according to claim 1, wherein the step c) further comprises:
determining whether the reply packet from the next node is received;
if the determination is negative, checking whether to provide partial QoS, and if the partial QoS is to be requested from the previous node, adding an address value satisfying the requested partial QoS into the reply packet and transmitting the reply packet to the previous node using the address system and the ARP; and
if the partial QoS is not requested, adding a default interface address value into the reply packet and transmitting the reply packet to the previous node using the address system and the ARP.

9. The method according to claim 8, wherein the destination address is an address of the physical layer 2.

10. A method for providing QoS (quality of service) using an address system and an ARP (address resolution protocol) in a network including a plurality of nodes, the method comprising the steps of:
a) at a current node, when an application program requests QoS, adding the QoS request information into a service request packet and transmitting the service request packet to a next node using the address system and the ARP;
b) at the current node, receiving a reply packet to the service request packet from the next node using the address system and the ARP;
c) at the current node, if receiving the reply packet indicating that the QoS request is satisfied, providing a service suitable for the QoS using an address of the next node included in the reply packet; and
d) at the current node, if receiving the reply packet indicating that the QoS request is not satisfied, providing a service suitable for default QoS.

11. The method according to claim 10, wherein the service request packet including the QOS request information is transmitted from a source node to a destination node through intermediate nodes in sequence.

12. The method according to claim 10, wherein the step c) further comprises reserving a necessary network resource for the QoS request.

13. The method according to claim 10, wherein the QoS request information is included in an address value of a physical layer 2 of the service request packet.

14. The method according to claim 10, wherein the step b) further comprises, at the current node, if not receiving the reply packet within a preset period of time, adding information indicating that the QoS request does not exist into the service request packet and transmitting the service request packet to an address of the next node.

15. A method for proving QoS (quality of service) in a network including a plurality of nodes using an address system and an ARP (address resolution protocol), the method comprising the steps of:
a) at a current node, if receiving a service request packet using the address system and the ARP, determining whether the service request packet includes QoS request information;
b) if the service request packet includes the QoS request information, determining whether an available network resource is capable of satisfying the QoS request;
c) if the determination is affirmative, reserving a necessary network resource for the QoS request, adding information indicating that the network resource is capable of satisfying the QoS request into a reply packet and transmitting the reply packet to a previous node using the address system and the ARP; and
d) if the determination is negative, adding information indicating that the network resource is not capable of satisfying the QoS request into a reply packet and transmitting the reply packet to the previous node using the address system and the ARP.

16. The method according to claim 15, wherein the service request packet including the QoS request information is transmitted from a source node to a destination node through intermediate nodes in sequence.

17. The method according to claim 15, wherein the QoS request information is included in an address value of a physical layer 2 within the service request packet.
